(19) United States
(12) Patent Application Publication
(10) Pub. No.: US 2019/0073178 A1
(43) Pub. Date: Mar. 7, 2019

(54) FLEXIBLE ELECTRONIC DISPLAY DEVICE

(71) Applicant: Medea Inc., Pleasanton, CA (US)

(72) Inventors: Brandon S. Laidlaw, Pleasanton, CA (US); Paul Ling, Pleasanton, CA (US); Margaret L. Taylor, Incline Village, NV (US); Jed Putterman, Mill Valley, CA (US)

(21) Appl. No.: 16/121,515

(22) Filed: Sep. 4, 2018

Related U.S. Application Data
(60) Provisional application No. 62/554,499, filed on Sep. 5, 2017.
(60) Provisional application No. 62/650,966, filed on Mar. 30, 2018.

(51) Int. Cl. G06F 3/14; G09G 3/14

(52) U.S. Cl. CPC G06F 3/1423; G09G 3/14; G09G 2370/022; G09G 2380/04; G09G 2370/16; G09G 2380/02

(57) ABSTRACT

A flexible electronic display device comprises a flexible circuit board, a plurality of components mounted to the flexible circuit board, and an adhesive on a backside of the flexible circuit board. The plurality of components includes one or more battery, one or more integrated circuits, and a plurality of light emitting elements.

### RELATED APPLICATIONS

This patent application claims the benefit under 35 U.S.C. § 119(e) of U.S. Provisional Application No. 62/554,499, filed Sep. 5, 2017, and further claims the benefit under 35 U.S.C. § 119(e) of U.S. Provisional Application No. 62/650,966, filed Mar. 30, 2018, both of which are herein incorporated by reference.

### TECHNICAL FIELD

Implementations described herein generally relate to electronic devices and more particularly to flexible electronic display devices that are capable of being attached to or integrated with objects and that can be controlled by mobile computing devices.

### BACKGROUND

Objects such as beverage containers, boxes, vases, and so on are often decorated with static designs and letters to attract the attention of prospective consumers. The static designs and letters are selected by the manufacturers and are not modifiable by a distributor, retailer or end consumer. Often in a retail setting, such as a store or bar, the beverage containers are placed on shelves to enhance their visibility to passing consumers.

### BRIEF DESCRIPTION OF THE DRAWINGS

Embodiments of present disclosure are illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

Reference will now be made to the accompanying drawings showing examples of the present application, and in which:

FIG. 1A is a diagram depicting a flexible electronic display device, in accordance with an embodiment of the present disclosure;

FIG. 1B is a diagram depicting a top down view of a flexible circuit board for a flexible electronic display device, in accordance with an embodiment of the present disclosure;

FIG. 1C is a diagram depicting a side view of the flexible circuit board of FIG. 1B;

FIG. 2 is a diagram depicting an example system architecture for a flexible electronic display device attached to an object and wirelessly connected to a mobile computing device, in accordance with an embodiment of the present disclosure;

FIG. 3 is a block diagram depicting an example system architecture for a flexible electronic device wirelessly connected to a mobile computing device, in accordance with another embodiment of the present disclosure;

FIG. 4 is a flow chart of an embodiment of a method for interfacing with a mobile computing device by a flexible electronic display device;

FIG. 5 is a flow chart of an embodiment for gathering and using information of users associated with flexible electronic display devices;

FIG. 6 illustrates multiple different areas of a mesh network and the distribution of a control message between the areas;

FIG. 7 is a flow chart of an embodiment of a method for synchronizing display of messages and/or light messages between multiple devices in a mesh network; and

FIG. 8 is a block diagram depicting an example computing device, in accordance with an embodiment of the present disclosure.

### DETAILED DESCRIPTION

Described herein are objects, such as beverage containers, with flexible electronic display devices attached thereto. As used herein, a flexible electronic display device is a thin flexible electronic device that is capable of displaying customized messages. A flexible electronic display device may have a thickness on the order of 1-3 mm in some embodiments, and can flex to assume many different shapes to conform with a surface to which the flexible electronic display device is attached. The flexible electronic display device may have an adhesive backing so that the electronic display device can be bonded to a surface. Since the flexible electronic display device is flexible, it can assume the shape of a surface of the object to which it is attached. Accordingly, the flexible electronic display device is effectively a programmable label. In embodiments, the flexible electronic display device runs on a battery and does not have access to frequent charging. Thus, flexible electronic display devices are devices for which battery life conservation may be important, and which may be optimized to extend battery life.

Flexible electronic display devices may form a wireless mesh network with other flexible electronic display devices and/or with other electronic display devices (e.g., rigid electronic display devices), and may propagate control messages to other electronic display devices in the wireless mesh network. A mobile computing device may provide initial control messages to electronic display devices in the wireless mesh network, and those electronic display devices in the wireless mesh network may forward those control messages to other electronic display devices in the wireless mesh network. The control messages may include a text message to display on the electronic display device, a light pattern to display on the electronic display device, and/or an instruction to display a message and/or light pattern already stored on the electronic display device. The electronic display devices may be configured to enable a wireless mesh network with a low latency over a large area (e.g., an area the size of a football stadium).

The flexible electronic display device may not be connected to a network (e.g., may not include a Wi-Fi network adapter or modem), and may rely on another computing device to act as a proxy for communication with a cloud based service. The flexible electronic display device may connect directly or indirectly to the other computing device that acts as a proxy for communication with the cloud based service. For example, the flexible electronic display device may be part of a mesh network (e.g., a Bluetooth mesh network), and one of the members of the mesh network may be the other computing device that acts as the proxy. Accordingly, messages to and from the cloud service may pass through multiple other flexible electronic display devices as well as the computing device that acts as a proxy. The cloud based service may include logic for controlling the flexible electronic display device, granting access to the flexible electronic display device, and so on.

Also described herein are an electronic device controller application that executes on a mobile computing device and an electronic device management service that runs on a server computing device. The electronic device controller application may receive data (e.g., a unique identifier) from flexible electronic display devices and forward such data to the electronic device management service for processing. The electronic device controller may act as a proxy (e.g., an Internet proxy) for the flexible electronic display device and other flexible electronic display devices, which may not have a capability to access the Internet or remote services. The electronic device controller application may also send command messages to electronic display devices. The command messages may originate on the electronic controller application or may be received from an electronic device management service.

There are shown in the drawings and will herein be described in detail several specific examples with the understanding that the present disclosure is to be considered as an exemplification of the principles of the described technology and is not intended to limit the technology to the examples illustrated.

The terminology used herein is for the purpose of describing particular embodiments only and is not intended to be limiting of the embodiments of the disclosure. As used herein, the singular forms “a”, “an” and “the” are intended to include the plural forms as well, unless the context clearly indicates otherwise.

It will be understood that like or analogous elements and/or components, referred to herein, may be identified throughout the drawings with like reference characters. It will be further understood that several of the figures are merely schematic representations of embodiments of the present technology.

Embodiments are discussed herein with reference to flexible electronic display devices that are attached to a container or bottle. However, embodiments also cover other types of electronic devices that mount to or are embedded in a container. Examples of other types of electronic display devices include rigid electronic display devices, electronic display bands, electronic display tags, and so on. Some other electronic devices may rely on displays of computing devices (e.g., of mobile devices carried by users) to display messages. Accordingly, it should be understood that discussion of flexible electronic display devices herein also applies to other types of electronic devices such as rigid electronic display devices and/or electronic display devices that do not have displays. Additionally, embodiments also apply to standalone electronic display devices that do not attach to any specific containers or other objects. Such other types of electronic display devices may be used instead of flexible electronic display devices, or may be mixed with flexible electronic display devices to form a bi-directional wireless mesh network. For example, a wireless mesh network may include multiple electronic display tags, rigid electronic display devices, stand-alone flexible electronic display devices and/or flexible electronic display devices attached to objects such as beverage containers (e.g., bottles), bases, hats, clothing, and so on. The other types of electronic display devices may include the same internal components, firmware and/or software programming as discussed herein with reference to flexible electronic display devices, but may have different form factors.

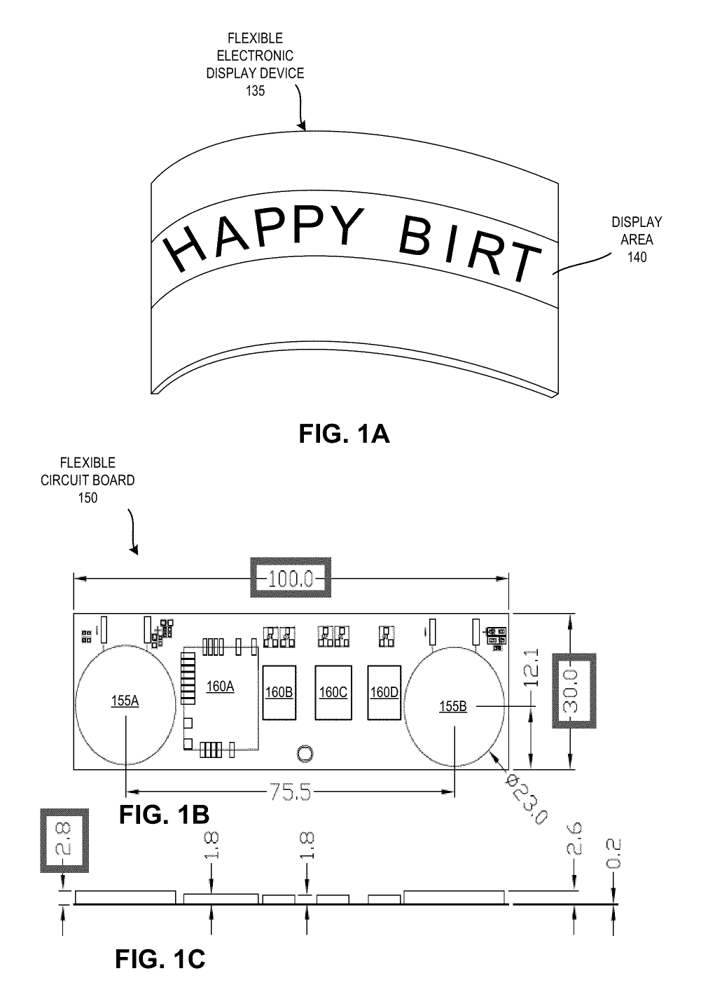

Referring to the figures, FIG. 1A is a diagram depicting a flexible electronic display device 135, in accordance with an embodiment of the present disclosure. The flexible electronic display device 135 includes a plurality of light emitting elements such as light emitting diodes (LEDs) that make up a display area 140. The flexible electronic display device 135 can be programmed to display a message in the display area 140. If the message includes more characters than can be displayed, then the message may be displayed as a running or scrolling message. The display area 140 may be capable of displaying text, numbers, shapes, and other images.

As shown, the flexible electronic display device 135 is thin and flexible. The flexible electronic display device 135 is shown having a curved or bent shape. However, many other shapes are possible. The flexible electronic display device can be bent along gradual or smooth curves as well as sharp curves and even right angles or sharper angles. This enables the flexible electronic display device 135 to be attached to many different shapes of surfaces. Some examples of surfaces to which the flexible electronic display device may be attached include a circular wrist band, a cylindrical bottle, a rectangular vase or other container, and so on.

A backside of the flexible electronic display device 135 may be coated with an adhesive. Accordingly, the flexible electronic display device 135 may function as a programmable label that can be attached to most any surface in the manner of a sticker. In some embodiments, the flexile electronic display devices include a plastic, rubber or other flexile enclosure. In some embodiments the flexible electronic display device does not include a rubber, plastic or other enclosure. Instead, the internal components of the flexible electronic display device may be exposed. Accordingly, a shrink wrap cover (e.g., heat shrink tubing) may be placed over the flexible electronic display device and the object to which the flexible electronic display device is attached. The shrink wrap cover may then be heated to adhere to the flexible electronic display device and the object to which the flexible electronic display device is attached. The shrink wrap cover may hide both the internal components of the flexible electronic display device as well as an interface of the flexible electronic display device and an object to which it is attached. In one embodiment, the shrink wrap cover has a window that corresponds to an area of the display area 140 of the flexible electronic display device 135. In another embodiment, the shrink wrap cover completely covers the flexible electronic display device. However, the shrink wrap cover may be composed of a material that is at least partially translucent to the wavelengths of light emitted by the flexible electronic display device 135. Accordingly, the flexible electronic display device may not be observable while it is turned off, but messages and images of the flexible electronic display device may be visible through the shrink wrap cover. In one embodiment, a sticker is placed over the flexible electronic display device and at least a portion of the object to which it is attached rather than using a shrink wrap cover. The sticker may serve a similar purpose as the shrink wrap cover, but may be used, for example, for shapes of objects in which a shrink wrap is not appropriate. The sticker may have a window that aligns to the display area 140, or may be composed of a material that is at least partially translucent to the wavelengths of the light emitted by the flexible electronic display device.

As shown, the flexible electronic display device 135 is longer than it is tall, and text scrolls horizontally. However, in an alternative configuration the flexible electronic device 135 may have a greater height than length, and text may scroll vertically.

FIG. 1B is a diagram depicting a top down view of a flexible circuit board 150 for a flexible electronic display device, in accordance with an embodiment of the present disclosure. FIG. 1C is a diagram depicting a side view of the flexible circuit board 150 of FIG. 1B. The flexible circuit board 150 may include mounted thereon one or more thin batteries 155A-B that power the flexible electronic display device. In one embodiment, the batteries 155A-B are welded to the flexible circuit board 150. Additionally, one or more integrated circuits (ICs) 160A, 160B, 160C, 160D may be mounted to the flexible circuit board 150. These ICs 160A-D may include a wireless module (e.g., a Bluetooth module), a system on a chip (SoC), a processor, a programmable logic controller (PLC), a memory, and/or other types of components.

FIGS. 1B and 1C show some example dimensions of various portions of the flexible electronic display device, in accordance with embodiments of the present disclosure. As shown, the flexible electronic display device may have a length of 100 mm, a width of 30 mm, and a height that varies between 1.8 and 2.8 mm. The flexible electronic display device may also have numerous other dimensions. Additionally, the thickness of the flexible electronic display device may be uniform in some embodiments.

The flexible electronic display device may additionally include a grid or array of light emitting elements mounted to the flexible circuit board 150 or to a second flexible circuit board laid over the flexible circuit board 150. The light emitting elements may be LEDs in embodiments. The grid of light emitting elements is not shown mounted to the flexible circuit board so as not to occlude the other elements.

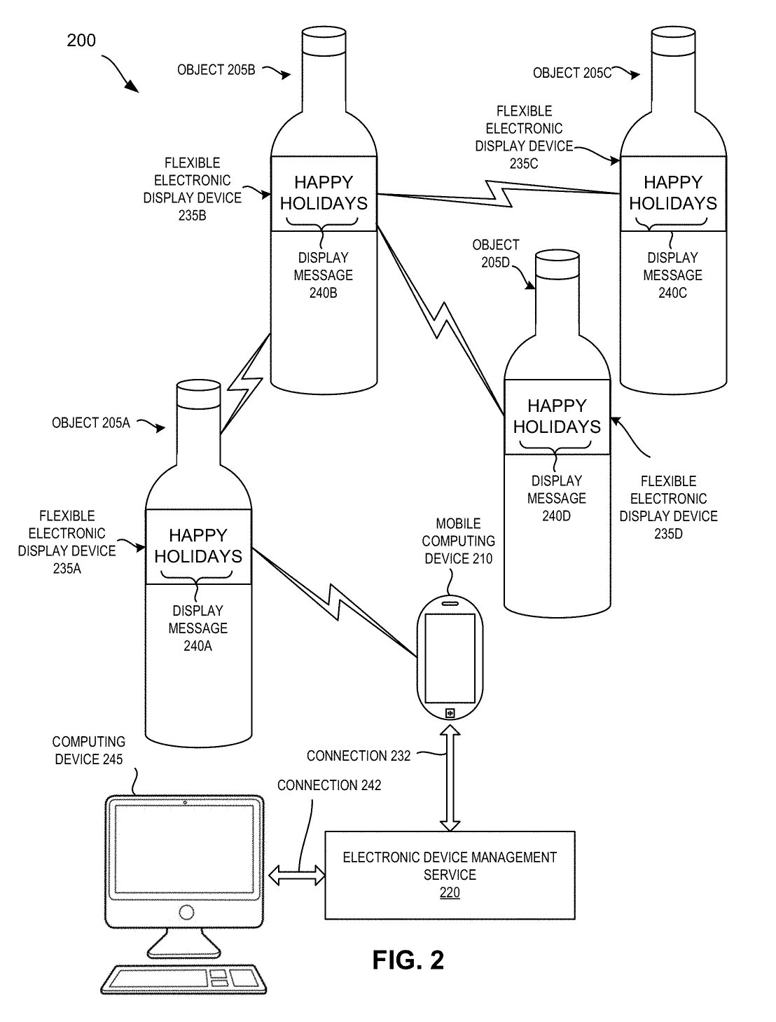

FIG. 2 is a diagram depicting an example system architecture 200 for a flexible electronic display device 235A attached to an object 205A and wirelessly connected to a mobile computing device 210, in accordance with an embodiment of the present disclosure. FIG. 2 depicts wireless propagation of messages to and between flexible electronic display devices 235A-D, in accordance with an embodiment of the present disclosure. Object 205A may be a container such as a bottle, box, cup, package, vase, etc. The object may also be other types of objects, such as a vehicle, wall, hat, etc. In the illustrated example, the object 205A is a cylindrical bottle. Also shown are similar flexible electronic display devices 235B, 235C and 235D attached to objects 205B, 205C and 205D, respectively.

Each flexible electronic display device 235A-D is attached to an object 205A-D. The flexible electronic display devices 235A-D may be attached to the same type of object or to different types of objects. Flexible electronic display devices 235A-D may be thin and flexible, and may be molded to the shape of a surface of objects 205A-D to which they are attached. A shrink cover may be placed over the flexible electronic display devices 235A-D and the object 205A-D, such that the flexible electronic display device 235A-D appears to be integrated with the object 205A-D.

Flexible electronic display device 235A-D conforms to the shape of the object 205A-D and is attached thereto, such as by wrapping or snapping onto the object (e.g., a bottle). Such an electronic display device 235A-D may adapt to any shape or size of container or other object. Optionally, such an electronic display device 235A-D may have a flexible screen or include a flexible image film technology to wrap around any object or container or product wrapper. For example, the electronic display device 235A-D may include a module with active components (e.g., LEDs, processing device, memory, battery, etc.) that is connected to a flexible circuit board that is included in a sleeve that can fit around a bottle. The sleeve may be plastic, polymer, rubber, or other flexible material. The sleeve may stretch to conform to the shape of the object that it is fit around.

Each flexible electronic display device 235A-C includes a wireless module that periodically broadcasts a low power radio signal. The low power radio signal may be broadcast every second, every 2 seconds, every half second, every 20 seconds, or at some other interval. The low power radio signals may be used to identify the flexible electronic display devices 235A-D and connect to nearby electronic display devices, and form a wireless mesh network. The low power radio signal may be transmitted using a protocol such as Bluetooth low energy (BLE), Bluetooth Mesh or iBeacon, and may include a unique identifier assigned to the flexible electronic display device 235A-D. In one embodiment, the unique identifier includes a universally unique identifier (UUID) that identifies an original equipment manufacturer (OEM) of the electronic display device 235A-D, a first assigned numerical value and a second assigned numerical value. If the iBeacon protocol is used, the low power radio signal includes the UUID, a major and a minor, where the major and minor are each 2 byte values.

A mobile computing device 210 executing an electronic device controller application (not shown) may enter a range of the flexible electronic display device 235A and receive the low power radio signal. The mobile computing device 210 may be a mobile phone, a tablet computer, a laptop computer, a portable game console, a digital camera, or other computing device. The electronic device controller application (App) may be configured for communicating with flexible electronic display devices of the OEM, and may include a user interface that enables a user of the mobile computing device 210 to control such flexible electronic display devices 235A-D.

The mobile computing device 210 may establish and/or maintain a wireless connection with a wireless carrier and/or with a local area network (e.g., via a wireless access point attached to the local area network). Through the wireless connection to the wireless carrier or local area network (LAN), the mobile computing device 210 may establish and/or maintain a connection to an electronic device management service 220. Responsive to receiving the low power radio signal, the mobile computing device 210 may generate a query that includes the received unique identifier (or a portion thereof, such as the major and minor) and information that identifies a user of the mobile computing device. The information that identifies the user of the mobile computing device may be user account information of a user logged into the electronic device controller application. The mobile computing device 210 may also determine its current location (e.g., latitude and longitude) and include the current location in the query. The mobile computing device 210 may then transmit the query to the electronic device management service 220 via the connection 232.

Electronic device management service 220 may process the query to determine whether the user has permission to access the flexible electronic display device and/or to determine whether any actions should be taken. In one embodiment, the electronic device management service 220 determines whether the user has permission to access the flexible electronic display device 235A and sends a response to the mobile computing device 210 indicating whether the user has such permission. If the user has permission to access the flexible electronic display device 235A, then mobile computing device 210 may notify the user of the presence of the flexible electronic display device 235A. Such notification may be performed by displaying an identity (e.g., assigned name) of the flexible electronic display device 235A in a display of the mobile computing device 210, triggering a haptic feedback module, generating an audio alert, and so on.

Once mobile computing device 210 receives notification that the user has access to the flexible electronic display device 235A, mobile computing device may present multiple command options for controlling the flexible electronic display device 235A via the user interface of the electronic device controller application. Such command options may include options to generate a message, send the message to the flexible electronic display device 235A, cause the flexible electronic display device to display the message or another message already stored on the flexible electronic display device, receive a battery level indication from the electronic display device, remotely power down the flexible electronic display device 235, and so on. Mobile computing device 210 may additionally establish a wireless connection 230 (e.g., using a bidirectional wireless communication protocol such as Bluetooth), and may send data such as commands and/or messages to the flexible electronic display device 235A via the wireless connection 230. For example, a user may type in the display message 240 “HAPPY HOLIDAYS” via the user interface and may then send the display message 240 to the flexible electronic display device 235A for display thereon.

In addition to receiving information about flexible electronic display device 235A from flexible electronic display device 235A, mobile computing device 210 may also receive information about flexible electronic display device 235B, flexible electronic display device 235C and/or electronic display device 235D. The information about the various flexible electronic display devices 235A-D may be sent through the flexible electronic display device 235A to the mobile computing device 210, for example. Accordingly, the mobile computing device 210 may receive information about many flexible electronic display devices at a location. In embodiments, mobile computing device 210 may receive information about tens, hundreds, thousands, or even tens of thousands of flexible electronic display devices. Mobile computing device 210 may then forward the information on to electronic device management service 220. Mobile computing device 210 may view a list of those flexible electronic display devices 235A-D that an account associated with the mobile computing device 210 has access to in embodiments.

A mesh protocol such as Bluetooth Mesh may be used by the various flexible electronic display devices 235A-D. Flexible electronic display devices 235C and 235D may connect to flexible electronic display device 235B via the mesh network protocol, and may transfer their UUIDs to flexible electronic display device 235B. Similarly, flexible electronic display device 235B may connect with flexible electronic display device 235A via the mesh network protocol, and may send to flexible electronic display device 235A the UUID of flexible electronic display device 235B and/or the UUIDs of flexible electronic display devices 235C, 235D. Flexible electronic display device 235A may therefore communicate to mobile computing device 220 the UUIDs of each of flexible electronic display devices 235A, 235B, 235C, 235D which mobile computing device 220 may forward to electronic device management service 220.

Electronic device management service 220 may include user accounts associated with each of the flexible electronic display devices 235A-D. Each user account may include information such as a user name, age, gender, interests, and so on. Additionally, electronic device management service 220 may update a location for each of the user accounts based on a location of mobile computing device 220. Additionally, electronic device management service 220 may determine an IP address associated with flexible electronic display devices and add the current IP address to the user account.

Electronic device management service 220 may generate a message (e.g., Happy Holidays) to send to each of the flexible electronic display devices 235A-D. These electronic display devices 235A-D may be associated with different user accounts and owned by different users. However, when the flexible electronic display devices 235A-D are collocated at a location, they may form a group, and may be messaged and/or controlled as a group. Accordingly, mobile computing device 220 may send the “Happy Holidays” message to flexible electronic display device 235A, which may display message 240A, and which may also forward the message to flexible electronic display device 235B. Flexible electronic display device 235B may display message 240B, and may also forward the message to flexible electronic display devices 235C, 235D, which may also display message 240C, 240D.

In addition to sending the same message and/or instruction to all of the flexible electronic display devices 235A-C in an area, electronic device management service 220 may generate different messages for display on each of the flexible electronic display devices and/or on various sub-groups of flexible electronic display devices. Flexible electronic display devices 235A-D may be grouped into one or more groups in a hierarchy of groups. The electronic device management service 220 may maintain a hierarchy of groups, which may include many different levels of groups. For example, electronic display devices may be grouped based on city, venue, zone within a venue, sub-zone within a venue, latitude and longitude, and so on. A master controller operating computing device 245 or mobile computing device 210 may be able to generate a message and/or instruction directed at every electronic display device included in a particular zone at a particular venue, in a particular city, for example. Each electronic display device 235A-D may include in its configuration an assignment to one or more groups in the hierarchy of groups. Mobile computing device 210 may broadcast the message and/or instruction (or otherwise send the message and/or instruction via the wireless mesh network), and the message and/or instruction may eventually be received by each of the electronic display devices 235A-D. Each electronic display device 235A-D, on receiving the message and/or instruction, may determine whether that receiving electronic display device 235A-D is within the groups that are to display the message. Each electronic display device 235A-D may additionally determine whether to broadcast the message and/or instruction. The message and/or instruction may propagate through large areas (e.g., such as venues the size of a football stadium) in less than 100 milliseconds in embodiments.

Each message and/or instruction generated by electronic device management service 220 or mobile computing device 210 may include a destination device and/or a destination group. A recipient device may receive the message, check if it is the destination device and/or in the destination group, and then forward it on to one or more next devices (e.g., if it is not the destination device or the destination is a group). Accordingly, the message will eventually reach the destination device and/or group. In some embodiments, the messages have a time associated with them such that they will be displayed at a particular time. This may enable each of the flexible electronic display devices 235A-D to display a message together as a group, even if it takes longer for some of the devices to receive the message. Other synchronization schemes are also discussed herein below. Messages can indicate text and/or images to display, colors to display, sounds to play, and so on.

In one embodiment, the flexible electronic display device 235A may be owned by the user of mobile computing device 210, but flexible electronic display device 235B-D may have different ownership. Responsive to electronic device management service 220 receiving the query from mobile computing device 210, electronic device management service 220 may determine owners of the flexible electronic display devices 235A-D, and may send a notification to those users (e.g., via email, text message, etc.). The notification may indicate an identity of the user of the mobile computing device 210 and/or a location (e.g., an IP address) of the flexible electronic display devices 235A-D. Alternatively, electronic device management service 220 may log the query, and the owner may use a computing device 245 to connect to the electronic device management service 220 (e.g., via a Web browser), and may view the log.

Mobile computing device 220 may be able to view and control one or more flexible electronic display devices 235A-D (which may be owned by a user of mobile computing device 220). However, mobile computing device 220 may not be able to view and/or control flexible electronic display devices 235B-D if they have different ownership. Alternatively, if flexible electronic display device 235B was owned by the user of mobile computing device 220, but flexible electronic display device 235A was not, then mobile computing device 220 may be able to view and control flexible electronic display device 235B but not flexible electronic display device 235A, even though mobile computing device is directly connected to flexible electronic display device 235A and only indirectly connected to flexible electronic display device 235B. In some embodiments, such as where mobile computing device 210 has master privileges, mobile computing device 210 may be able to control all of the electronic display devices 235A-D.

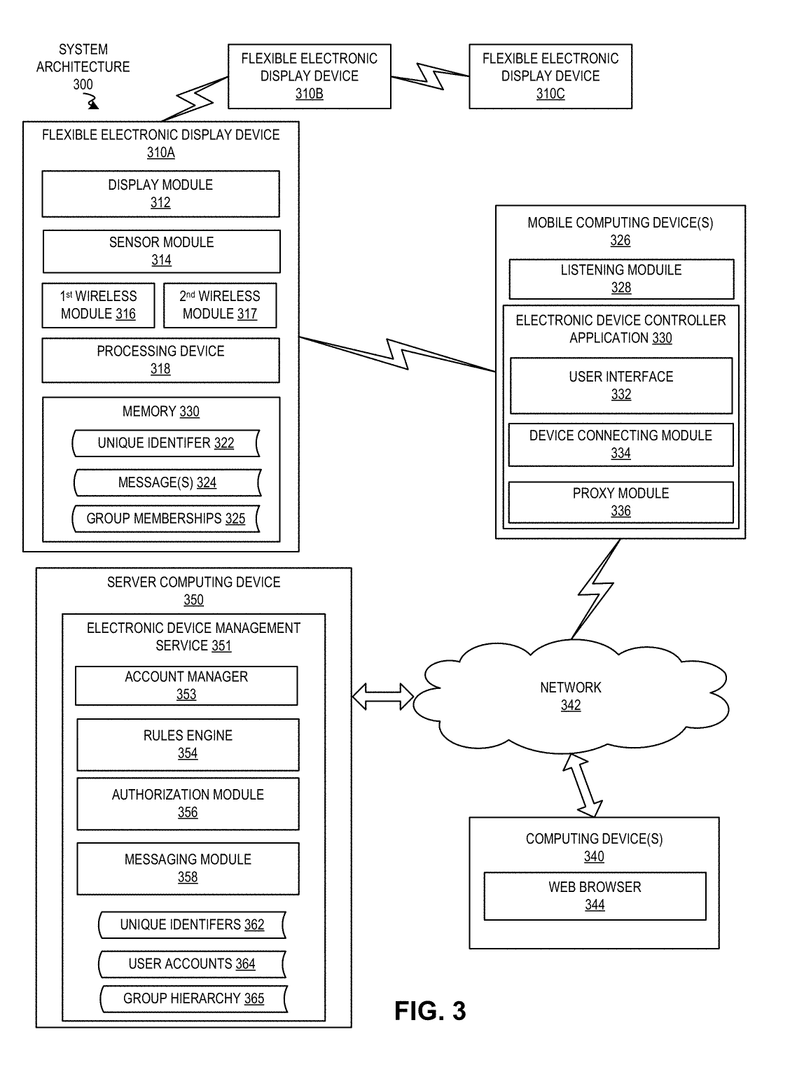

FIG. 3 is a block diagram depicting an example system architecture 300 including a flexible electronic display device 310A, one or more mobile computing devices 326, and a server computing device 350. Also shown are additional electronic display devices 310B-C. In one embodiment, system architecture 300 corresponds to system architecture 300 of FIG. 2. Flexible electronic display device 310A may be communicably coupled to the one or more mobile computing devices 326 via wireless connections. As discussed above, these wireless connections (e.g., Bluetooth connections) may be established responsive to server computing device 350 determining that the mobile computing devices 326 have permission to access the flexible electronic display device 310A. Alternatively, these wireless connections may be established regardless of ownership. For example, wireless connections may be established to form a wireless mesh network of devices at a bar, where different devices may belong to different users. In one example, flexible electronic display device 310A may be a portable display associated with or a part of (e.g., attached to) an object, such as a beverage container.

Flexible electronic display device 310 may include a display module 312, a sensor module 314, a first wireless module 316, a second wireless module 317, a processing device 318, a memory 320, and/or other hardware, firmware and/or software modules. One or more of the modules, processing device and/or memory may be an integrated circuit. Memory 320 may store an assigned unique identifier 322 that identifies an OEM associated with the flexible electronic display device and uniquely identifies the flexible electronic display device 310A of that OEM. Memory 320 may additionally store a group hierarchy and group memberships 325 of the electronic display device 310A to groups in one or more levels of the group hierarchy. Electronic display device 310A may belong to any number of groups in any number of layers in a group hierarchy. Memory 320 may additionally store one or more messages 324 that may be displayed by display module 312. In one embodiment, memory 320 also stores a password. In one embodiment, one or more of the wireless module 316, processing device 316 and/or memory 320 are components of a system on a chip (SoC).

Display module 312 may include an electronic visual display that may be illuminated to display an image or alphanumeric message. Display module 312 may include a grid of light emitting elements. Each light emitting element may be or include light emitting diodes (LEDs), organic light emitting diodes (OLEDs), liquid crystal display (LCD), or elements of other similar display technology. The image or alphanumeric message displayed by the display module 312 may be static or may be displayed in a manner that appears to show movement (e.g., motion picture or scrolling text). Display module 312 may have a variety of sizes and include pixels of various colors. In one example, display module 312 may cover a portion of an object's exterior face or the entire exterior face of the object in all angles (0 degrees to 360 degrees).

In one example, display module 312 may be used for advertising or displaying various images or messages, such as greetings, calendar events (e.g., birthdays, anniversaries, holiday messages, events of cultural significance), etc. Optionally, the display module 312 may utilize animated images or messages. For example, messages may scroll from any direction, strobe, glow, etc. The messages or images may allow objects holding the flexible electronic display devices to serve as an advertising or marketing channel. The marketing channel may allow for multiple levels of distribution (e.g., directly to customers, through a distributor, etc.). A customizable communication or message allows for maximum flexibility.

Sensor module 314 may include one or more sensor devices for gathering data associated with the object and/or flexible electronic display device 310. The sensor devices may include audio sensors (e.g., microphones), motion sensors (e.g., accelerometer, gyroscope, etc.), fluid measuring sensors (e.g., mechanical gyrator), lights sensors (e.g., ambient light sensor), location sensors (e.g., global positioning system sensors (GPS)), temperature sensor (e.g., thermometer), or other similar sensing devices. Data generated by sensor module 314 may be forwarded by mobile computing devices 326 to server computing device 350 for processing. For example, an audio signal may be sent to server computing device 350 to perform speech to text processing.

First wireless module 316 and/or second wireless module 317 may enable flexible electronic display device 310A to receive and transmit messages and commands. First wireless module 316 and/or second wireless module 317 may include a radio (e.g., a transmitter, receiver, transceiver, antenna, and so forth), a memory, etc. for communicating with a computing device (e.g., with mobile computing devices 326). In one embodiment, first wireless module 316 includes a Bluetooth wireless adapter capable of communicating using multiple different Bluetooth based protocols (e.g., iBeacon, low energy Bluetooth, Bluetooth Mesh, Bluetooth, etc.). The first wireless module 316 may include a single radio (e.g., with a single antenna) that may both send and receive data simultaneously using a first frequency band to send data and a second frequency band to receive data. The first wireless module 316 may hop between a preset number (e.g., three) of frequency bands for the sending and receiving of data. In one embodiment, second wireless module 317 may include a wireless adapter that uses protocols for Near Field Communication (NFC), Wi-Fi®, infrared (IR), Linux® wireless, Zigbee®, or any other low frequency RF modulation protocol. In one embodiment, electronic display device 310A includes only a single wireless module. In one embodiment, the single wireless module is a Bluetooth radio. In one embodiment, the single wireless module includes a Bluetooth radio and an RF radio.

First wireless module 316 may be used to initiate or establish wireless connections to mobile computing devices 326 and/or to other flexible electronic display devices 310B, 310C. The connections may include direct connections and indirect connections. Direct connections may directly connect flexible electronic display device 310 with a mobile computing device 326 and may not use any intermediate flexible electronic display devices to forward messages. Indirect connections may rely on one or more intermediate flexible electronic display devices to forward messages.

In one embodiment, first wireless module 316 is configured to form a wireless mesh network with mobile computing devices 326 and/or the wireless modules of other flexible electronic display devices (e.g., electronic display devices 310B-C). The wireless mesh network may be a bi-directional mesh network implemented using Bluetooth Mesh. Bluetooth Mesh networking uses Bluetooth Low Energy (LE) as the protocol stack to send and receive messages.

However, Bluetooth Mesh is designed to accommodate at most a few hundred to thousand devices located within a relatively small area such as a household. In contrast, in embodiments first wireless module 316 is configured to implement Bluetooth Mesh with up to tens of thousands or hundreds of thousands of devices in large areas (e.g., having a size of up to a football stadium). A single electronic display device 310A may communicate directly with thousands of other devices (e.g., flexible electronic display devices and/or mobile computing devices) with minimal delay in a manner that enables the devices to display messages (e.g., text messages) and/or light patterns synchronously. Accordingly, the first wireless module 316 is implemented to send messages using a one-to-many and/or many-to-many relationship, where many may be up to thousands of devices.

The first wireless module 316 (and first wireless modules of the other flexible electronic display devices) are configured to ensure 100% delivery of messages to all flexible electronic display devices in an area in a time scale of under 100 milliseconds from the time that a first message is sent to a time when the very last flexible electronic display device in the mesh network receives the message. In embodiments, the first wireless module 316 is configured to make decisions regarding whether to forward data (e.g., messages and/or commands) within the mesh network based on one or more of a number of hops that the data has traveled, how long it has been since the data was generated, a time of flight for the data, and so on.

In one embodiment, flexible electronic display device 310A includes a single Bluetooth radio. For example, a single Bluetooth radio may be included in first wireless module 316 and/or connected to first wireless module 316. The single Bluetooth radio may be used to communicate with mobile computing device(s) 326 as well as one or more other flexible electronic display devices (e.g., flexible electronic display devices 310B-C). The single Bluetooth radio may hop between three different frequency bands for sending and receiving data. In one embodiment, the Bluetooth radio sends and receives data concurrently using different frequencies. For example, the Bluetooth radio may receive data from mobile computing device 326 at a first frequency and may concurrently send the same data or other data to electronic display device 310B at a second frequency.

In one embodiment, the flexible electronic display device 310A includes two buttons usable for basic control of the electronic device. The two buttons may include a power button, which may be used to turn on and off the flexible electronic display device. In one embodiment, the power button is usable to toggle through different modes of operation for the flexible electronic display device 310A. The modes of operation may include an unpowered mode, a sleep mode in which most of the components of the low power electronic display are unpowered (e.g., in which no radio signals are broadcast and a display is disabled), a display state in which a message is displayed by the display module 312 and the wireless module periodically transmits a low power radio signal, and/or a broadcast mode in which the display module 312 is unpowered but the first wireless module 316 broadcasts the low power radio signal at an interval.

Mobile computing devices 326 may be any portable devices capable of communicating with flexible electronic display device 310A that include an electronic device controller application 330 installed thereon. Examples include smart phones, tablet computers, laptops, etc.

Mobile computing devices 326 may include a listening module 328 and the electronic device controller 330. Listening module 328 may run in a background of mobile computing devices 326 and may listen for low energy radio signals that include a unique identifier 322 of any flexible electronic display device 310A-C manufactured by a particular OEM. Such low energy radio signals may be short range signals that are periodically broadcast by the first wireless module 316. Responsive to receiving such a low energy radio signal, listening module 328 may load electronic device controller application 330. Alternatively, listening module 328 may perform other operations such as generate a query and send the query to the server computing device 350.

In one embodiment, electronic device controller application 330 is a program (e.g., an App) that runs on mobile computing devices 326. In one example, electronic device controller application 330 may be a downloadable application for a mobile device. For example, mobile devices may include Android®, iPhone®, or Blackberry® devices capable of running a software application (e.g., Android Smart Bottle software App, iPhone Smart Bottle software App, Blackberry Smart Bottle software App, etc.). Alternatively, electronic device controller application 330 may be firmware and/or a hardware logic on a mobile computing device 326. Electronic device controller application 330 may act both as a controller for flexible electronic display devices (which may lack their own user interfaces) and as a proxy for providing network connectivity (e.g., an Internet connection) to the flexible electronic display devices 310. In one embodiment, electronic device controller application 330 includes a user interface 332, a device connecting module 334 and a proxy module 336.

Proxy module 336 communicates with electronic device management service 351 on behalf of flexible electronic display devices 310A-C. Proxy module 336 may establish a connection to electronic device management service 351 on server computing device 350 via network 342. Network 342 may include a public network (e.g., the Internet), a private network (e.g., a local area network (LAN) or wide area network (WAN)), or a combination thereof. Network 342 may also include a wired network (e.g., Ethernet network), a wireless network (e.g., an 802.11 network or a Wi-Fi network), a cellular network (e.g., a Long Term Evolution (LTE) network), or combination thereof, and may include a wireless access point, network routers, switches or other similar network devices.

Responsive to mobile computing device 326 receiving data from flexible electronic display device 310A (e.g., a unique identifier received in a low energy radio signal), proxy module 336 may forward that data to server computing device 350 for processing by electronic device management service 351. The received data may be data about flexible electronic display device 310A, data about flexible electronic display device 310B and/or data about flexible electronic display device 310C. Proxy module 336 may generate queries and/or other messages for electronic device management service 351, which may include the data received from the flexible electronic display device 310A as well as other data generated or received by mobile computing device 326. Data from the flexible electronic display device 310A may include unique identifiers assigned to each of the flexible electronic display devices 310A-C, battery states of the flexible electronic display devices 310A-C, messages stored on the flexible electronic display devices 310A-C, group memberships of electronic display devices 310A-C, acceleration data, speech data, rotational data, proximity sensor data, light sensor data, temperature data, and so on. Data from the mobile computing device 326 may include location data (e.g., a geo location, an IP address, etc.), user account data, date and time, signal strength data (e.g., of the low energy radio signal received from the flexible electronic display device 310A), and so on.

Electronic device management service 351 may include a rules engine 354 (discussed further below) that processes received data to determine whether any actions are to be taken. Proxy module 336 may then receive a response message from the electronic device management service 351 based on an output of the rules engine 354. For example, proxy module 336 may receive an indication as to whether the user of the mobile computing device has permission to access any of the flexible electronic display devices 310A-C. Proxy module 336 may additionally receive messages to be displayed to the user via user interface 332 and/or instructions to send messages and/or commands to the flexible electronic display device 310A (which may or may not be forwarded by flexible electronic display device 310A to the other flexible electronic display devices 310B-C). Such messages and/or instructions may be sent to the flexible electronic display device 310A whether or not the user has access to the flexible electronic display device. For example, if the user does not have access to the flexible electronic display device 310A, then such messages and/or commands may be sent to the flexible electronic display device without notifying the user of the mobile computing device of the presence of the flexible electronic display device or the fact that the mobile computing device 326 is communicating with the flexible electronic display device 310.

User interface 332 may act as a remote user interface for flexible electronic display devices 310A-C. User interface 332 may be a graphical user interface or a command line user interface. If a user of the mobile computing device 326 has access to any of the flexible electronic display devices 310A-C (e.g., as decided by electronic device management service 351), then the user interface may display a presence of those flexible electronic display devices 310A-C as well as command options for controlling the flexible electronic display devices 310A-C.

One example command option includes a command to generate a new message and/or send the new message to a flexible electronic display device 310A-C. If a user selects a generate message option, user interface 332 may present a virtual keyboard with alphanumeric characters that the user may type on to create a new message. Alternatively, a user may speak into a microphone of the mobile computing device 326, and electronic device controller application 330 may generate an audio file and transmit the audio file to electronic device management service 351 or a separate transcription service to translate the speech into text. The text may then be sent back to the mobile computing device 326 and used for the message. Alternatively the mobile computing device 326 may include a local transcription module that translates speech to text for a new message. Once the new message is created, the user may select a set message command option and select one or more flexible electronic display devices to send the message to.

Other command options include a display message command, a report messages command, a set unique identifier command, a disable display command, a read battery level command, a read display state command, a change broadcast rate command, and so on. The display message command causes a selected low energy electronic device to display a selected message, which may already be stored on the low energy electronic device or may be sent to the flexible electronic display device for display.

Any command and/or message may be directed to a single flexible electronic display device 310A-C or to one or more groups of electronic display devices 310A-C. For example, the display message command and/or associated message may be directed to a particular group and/or a particular flexible electronic display device within a group hierarchy. For example, the display message command may be directed to devices belonging to a regional group (e.g., CA), a sub-regional group (e.g., San Francisco), a venue group (e.g., Giants Stadium), and a zone group (e.g., zone A). The mobile computing device 326 may send the display message command to electronic display device 310A, which may determine based on its group memberships 325 whether the display message command is directed to it. If the electronic display device 310A is included in the group to which the display message command is directed, then electronic display device 310A may display a particular message. If the electronic display device 310A is not in the group, then the electronic display device 310A may not display the message. In either case, the electronic display device 310A may use the mesh network that was joined by first wireless module 316 to deliver the display message command to many other electronic display devices (e.g., to electronic display devices 310B-C). Each electronic display device may then make its own decision as to whether that electronic display device should display the message and/or whether that electronic display device should forward the display message command. All of the electronic display devices and/or groups of electronic display devices at a particular venue are able to display messages and/or light patterns together (e.g., in a synchronized manner) in embodiments.

The set unique identifier command changes a value of a unique identifier assigned to a flexible electronic display device. Flexible electronic display devices may be manufactured with a default identifier, and that identifier may be replaced with a unique identifier after the flexible electronic display device is powered on by a user for a first time. In one embodiment, the unique identifier is a pair of integers (e.g., a major and a minor as defined by the iBeacon protocol). These numerical values in one embodiment are each 3 byte values. The two numerical values may be combined to create a single larger numerical value (e.g., a 4 byte numerical value). By combining, for example, two independent 3 byte values, each of which has 65,536 possible unique values into a single unique 4 byte value, the number of possible unique values is increased many times to 4,294,967,296 possible values.

The report messages command may cause a flexible electronic display device to notify the electronic device controller 330 of all messages currently stored on the flexible electronic display device. The flexible electronic display device may broadcast a low energy radio signal on a periodic basis to notify nearby mobile devices of its identity. The change broadcast rate command may be used to adjust the frequency at which the low power radio signal is broadcast. A less frequent broadcast may improve a battery life of the flexible electronic display device.

Device connecting module 334 is responsible for establishing wireless connections to flexible electronic display devices (e.g., to flexible electronic display device 310A). In one embodiment, device connecting module 334 establishes a direct bidirectional peer-to-peer connection to the flexible electronic display device (e.g., a Bluetooth connection). In one embodiment, device connecting module 334 joins a mesh network (e.g., a Bluetooth Mesh network) including multiple electronic devices 310A-C. In one embodiment, device connecting module 334 may establish an indirect connection to the flexible electronic display device (e.g., a Wi-Fi connection to a local area network (LAN) that the flexible electronic display device is also connected to.

Server computing device 350 may be a desktop computer, rackmount server, blade server, or other physical machine used to host a server. Server computing device 350 hosts electronic device management service 351. In one embodiment, server computing device 350 includes a virtual machine monitor (also referred to as a hypervisor) that hosts virtual machines, and the electronic device management service is a service that executes in a virtual machine hosted by the server computing device 350. For example, electronic device management service 351 may be a cloud based service that is hosted by Amazon's® Elastic Compute Cloud (EC2).

Electronic device management service 351 is a service for managing the interaction with flexible electronic display devices and/or other electronic devices. Electronic device management service 351 may include a rules engine 354, an authorization module 356 and/or a messaging module 358. Alternatively, the functionality of one or more of the rules engine 354, authorization module 356 and/or messaging module may be combined into a single module or divided into additional modules.

Authorization module 356 is responsible for determining whether a user of a mobile computing device 326 is authorized to access a flexible electronic display device. Electronic device management service 351 may receive a query from a mobile computing device 326 (e.g., from a proxy module 336), the query including a unique identifier of a flexible electronic display device and user account information of a user of the mobile computing device. Authorization module 356 may perform a lookup on the user account and the unique identifier, which may be stored in a data structure (e.g., a database, table, etc.) including assigned unique identifiers 362 and user accounts 364. A user may have access to a flexible electronic display device if that user owns the device or if access to the device has been shared with the user (e.g., by the owner) or if that user has a master control status (e.g., for a venue). If the user account has access to the flexible electronic display device associated with the received unique identifier, then messaging module 358 sends a response message back to the mobile computing device 326 indicating that the user has access permissions. Otherwise the messaging module 358 may send a response indicating that the user does not have such access permissions.

In some instances a flexible electronic display device may have a default unique identifier, and may not be associated with any user account. When a query that includes such a default identifier is received, authorization module 356 may determine an unused unique identifier, and may assign that unused unique identifier to the flexible electronic display device. Authorization module 356 may generate an ownership record for the user account associated with the received query, where the ownership record includes the unique identifier. Messaging module 358 may transmit a response to the mobile computing device 326 from which the query was received, where the response includes the assigned unique identifier. The response may also include an instruction to program the flexible electronic display device to have the unique identifier. The electronic device controller application 330 of the device connecting module 334 may then connect to the flexible electronic display device (if a connection has not already been established), and may send an instruction to the flexible electronic display device to overwrite the default identifier with the assigned unique identifier.

Data from received queries may also be input into rules engine 354. Rules engine 354 may include one or more rules, and may apply these rules to generate commands, perform actions, and/or generate messages based on received data. Actions that are performed may include sending messages and/or notifications to specific users (e.g., to owners), sending messages to mobile computing devices for presentation thereon, sending commands to mobile computing devices that cause them to connect to flexible electronic display devices and send or forward commands to those flexible electronic display devices (e.g., to display a message on a flexible electronic display device), and so on. In one embodiment, authorization module 356 is a component of rules engine 354, and is implemented via an authorization rule and/or a new device rule. Rules engine 354 may include any number of rules, which may be used to perform many different actions. Some example rules and resultant actions are provided, but should not be construed as limiting the scope of the rules engine.

A first example rule is an owner notification rule. The owner notification rule may cause the rules engine to generate a notification which messaging module 358 sends to an owner of an electronic device if a mobile device belonging to someone other than the owner comes within range of the electronic device. For example, when a mobile computing device 326 executing an electronic device controller application 330 comes within range of the low energy radio signal broadcast by flexible electronic display device 310A, that electronic device controller application 330 may generate a query and send the query to electronic device management service 351. The query may include the unique identifiers of one or more of the flexible electronic display devices 310A-C that are near to one another, user account information associated with the mobile computing device 326 and a location of the mobile computing device (e.g., as determined via a global positioning system (GPS) receiver in the mobile computing device).

Rules engine 354 may apply the owner notification rule, and may determine that the user account is not for an owner of the flexible electronic display device 310. Messaging module 358 may then generate a notification that the mobile computing device is near the flexible electronic display device and that the flexible electronic display device is at the location, and send the notification to the owner. The notification may be sent by posting it to a social network account of the owner, by sending an email to an email address of the owner, by sending a text message to a phone number of the owner, or by other means. For example, the notification may be sent to a computing device 340 of the owner, which may be a mobile computing device that includes an instance of the electronic device controller application and/or a web browser 344. If the computing device 340 does not include the electronic device controller application 330, then a user of the computing device 340 may use the web browser to access a web page provided by electronic device management service 351. The web page may indicate users who have come within range of flexible electronic display devices owned by the user, the times of such encounters, locations of those flexible electronic display devices, and so forth.

Responsive to receiving a notification, a user may send a response back to electronic device management service 351. The response may include a command to send a message to the electronic device, a command to send a message to the mobile computing device and/or a command to perform another action. The electronic device management service 351 may then perform the action in accordance with the command in the response.

As discussed above, in some instances flexible electronic display devices may be logically divided into one or more groups, and a user may select a group to send a message and/or command to. A user with access to multiple electronic devices may generate any desired groupings and/or hierarchical structure of groupings for controlling the electronic devices. This enables the user to easily select a set of electronic devices and perform the same action with regards to each of these electronic devices. For example, a user may generate a top level group for all of the electronic devices in a store, and different second level groups for each floor of the store. The user may then select the top level group to select all electronic devices in the store, or one of the second level groups to select all of the electronic devices on one of the floors. In one embodiment, flexible electronic display devices are automatically grouped based on location. The flexible electronic display devices that are within range of one another may connect directly or indirectly using a mesh protocol (e.g., Bluetooth Mesh), and may set up a group based on their proximity.

In one embodiment, electronic device management service 351 includes an account manager 353. When a user installs the electronic device controller application 330 on their mobile computing device and/or otherwise sets up a user account, account manager 353 may be invoked. Account manager 353 receives user information, generates a user account, and assigns the user information to the user account. Account manager 353 may additionally assign a UUID for a flexible electronic display device owned by the user to the user account. In one embodiment, a user inputs an email address, and through the email address account manager 353 retrieves user information such as name, age, gender, and so on. Alternatively, or additionally, a social network service account may be provided by a user and tied to the user account. This may provide much additional information about the user.

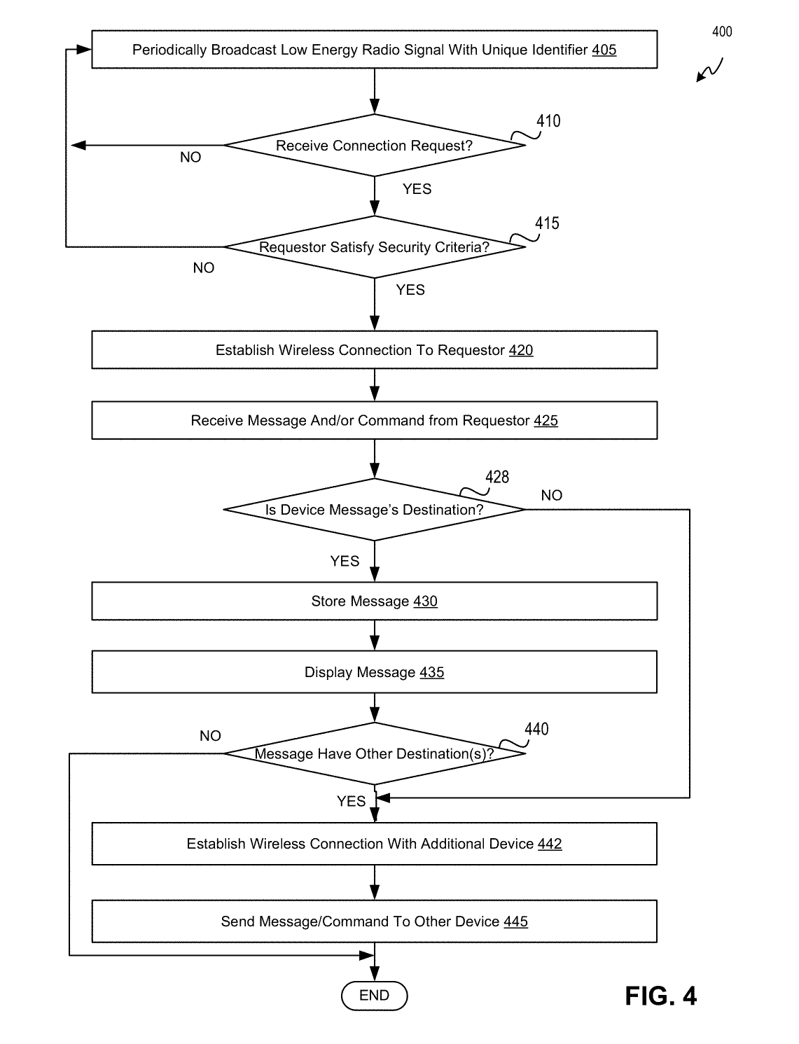

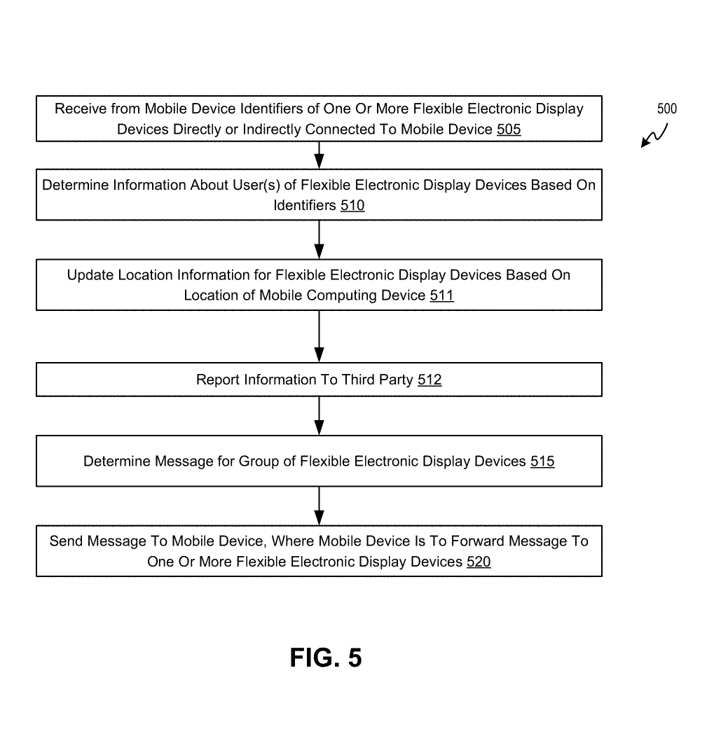

FIGS. 4-5 depict flow charts of multiple illustrative examples of methods 400, 500 (hereafter “methods”) for controlling one or more flexible electronic display devices using a mobile phone (or other mobile computing device) and/or remote server. The methods and each of their individual functions, routines, subroutines, or operations may be performed by processing logic of a flexible electric display device, mobile computing device, or server computing device executing the method. The processing logic may include hardware, software, firmware, or a combination thereof. For example, processing logic may include a general purpose and/or special purpose processor that executes instructions for performing the methods.

Referring to FIG. 4, at block 405 of method 400 processing logic of a flexible electronic display device such as a programmable label periodically broadcasts a low energy radio signal that includes a unique identifier. The periodic broadcast may be generated in accordance with a first wireless protocol, such as a Bluetooth low energy (BLE) protocol, a Bluetooth Mesh protocol or the iBeacon protocol. At block 410, processing logic determines whether a connection request has been received. The connection request may be a request from another flexible electronic display device or from a mobile computing device (e.g., a mobile phone). If a connection request is received, the method continues to block 415. Otherwise, the method returns to block 405.

At block 415, processing logic determines whether a requestor of the connection satisfies one or more security criteria. If the connection request matches a security criterion, the method continues to block 420. Otherwise, the method returns to block 405.

At block 420, processing logic establishes a wireless connection to the requestor. This wireless connection may be established in accordance with the wireless protocol or with a second wireless protocol. In one embodiment, the wireless connection is a bidirectional peer-to-peer Bluetooth connection established in accordance with the Bluetooth protocol. In one embodiment, the connection is a Bluetooth Mesh connection.

At block 425, processing logic receives a message from the requestor. The message may be a message generated by the requestor, or a message that was forwarded to the requestor by another device, which may be another flexible electronic display device or a mobile computing device.

At block 428, processing logic determines whether the flexible electronic display device of processing logic is the message's destination. If so, the method proceeds to block 430 and processing logic stores the message. At block 435, processing logic may display the message. In one embodiment, the message is displayed responsive to an additional command from the requestor to display the message. If the flexible electronic display device of processing logic is not the destination, then the method continues to block 442.

At block 440, processing logic determines whether the message also has an additional destination. For example, the message may have indicated two devices to receive the message. Alternatively, or additionally, the message may have indicated a group of devices to receive the message. If the message had no additional destinations, then the method ends. If the message had one or more additional destinations, then the method proceeds to block 442.

At block 442, processing logic establishes a wireless connection with one or more additional device (e.g., to one or more additional flexible electronic display devices using the Bluetooth Mesh protocol). Alternatively, such a connection may have already been established (e.g., via a mesh network). At block 445, processing logic sends the message to the other device. In one embodiment, processing logic synchronizes the flexible electronic display device of processing logic to one or more nearby flexible electronic display devices. Once the devices are synchronized, they may perform operations together as a group, such as display the same message at the same time, blink on and off or between a pattern of colors together, and so on.

FIG. 5 is a flow chart of an embodiment for a method 500 of gathering and using information of users associated with flexible electronic display devices. At block 505 of method 500, processing logic receives from a mobile device identifiers (e.g., UUIDs) of one or more flexible electronic display devices directly or indirectly connected to the mobile device. A first one of the flexible electronic display devices will be directly connected to the mobile computing device. One or more of the other flexible electronic display devices may be connected to the first flexible electronic display device and/or one or more other intermediate flexible electronic display devices, and through the first electronic display device and/or one or more other intermediate flexible electronic display devices to the mobile computing device.

At block 510, processing logic determines information about users of the flexible electronic display devices based on the received identifiers. Each identifier may be associated with a particular user account, which may include user information. Accordingly, the identifiers (e.g., UUIDs) may be used to look up one or more user accounts, and the user accounts may indicate user information. At block 511, processing logic updates a location of each of the identified flexible electronic display devices based on a location of the mobile computing device. This location information may include an Internet protocol (IP) address and/or a geo location. The location of the mobile computing device may have been provided by the mobile computing device along with or separate from the identifiers. At block 512, processing logic may report information such as user information of the users associated with the detected flexible electronic display devices to a third party. For example, the flexible electronic display devices may be on wristbands worn by people attending a concert, may be on flexible electronic display devices on alcohol bottles at a bar of a venue for the concert, and so on. The third party may be an owner of the venue. Accordingly, the owner of the venue may receive information regarding the crowd at their establishment.

At block 515, processing logic determines a message for a group of flexible electronic devices. The group of flexible electronic devices may be flexible electronic devices that are at a particular venue, for example. These devices may be synchronized together via a mesh protocol such as the Bluetooth Mesh protocol. At block 520, processing logic sends the message to the mobile device. The mobile device may then forward the message to at least one flexible electronic display device to which it is wirelessly connected. That flexible electronic display device may then forward the message to one or more additional flexible electronic display devices, which in turn may forward the message to still other flexible electronic display devices, and so on. All of the flexible electronic display devices may then display the message.

In one embodiment, processing logic generates multiple messages and/or commands, each of the messages and/or commands having a different destination group. The flexible electronic display devices at a location may be divided into multiple groups, and a different message may be assigned for each of the groups. This may enable to flexible electronic display devices to light up and/or display messages in patterns based on their group membership.

As set forth above, in embodiments the flexible electronic display devices described herein provide a unique implementation bi-directional wireless mesh network to exchange commands and/or messages that cause one or a group of flexible electronic display devices to display messages and/or emit light colors and/or light patterns together. The bi-directional wireless mesh network may ensure that many flexible electronic display devices, which may be separated by hundreds of meters or more, display messages and/or light patterns together in a synchronized manner in embodiments. In contrast, existing mesh network solutions would cause lag between message and/or light displays between devices, causing the devices to lack synchronization.

One example implementation of the bi-directional wireless mesh network is set forth below, in accordance with embodiments of the present disclosure. The structure of control messages used for controlling the flexible electronic display devices (or other electronic display devices) from a single source device is provided in the example. In embodiments, the messages may be sent over Bluetooth low energy (BLE). Control messages may be BLE advertising messages in embodiments. Control messages may be sent over two of three available advertising channels provided by the BLE protocol in embodiments. A source device (e.g., a device generating a control message) should advertise only on the two first channels of the three available BLE channels in some embodiments.

A control message may originate from a single source device, which may act as the entry point of new control messages into the bi-directional wireless mesh network composed of multiple flexible electronic display devices. For example, the control message may be generated by an application (app) on a mobile computing device such as a mobile phone, a tablet computer, a laptop computer, and so on. The control message generated by the source device may be a BLE advertising message. Flexible electronic display devices that receive the BLE advertising message that includes the control message (e.g., that includes a command to display a message and/or to output a particular light pattern) may modify the received BLE advertising message and then re-broadcast or echo the modified version of the BLE advertising message to other flexible electronic display devices and/or other electronic display devices. Those other flexible electronic display devices may receive the BLE advertising message, modify the received BLE advertising message (e.g., by incrementing a value that represents a number of electronic display devices the BLE advertising message has passed through) and then re-broadcast or echo the modified version of the BLE advertising message to other flexible electronic display devices and/or other electronic display devices.

Alternatively, the control message generated by the source device may be another type of BLE message such as a BLE characteristic declaration message and/or a characteristic value declaration message. A first flexible electronic display device or set of flexible electronic display devices may act as gateways to the bi-directional wireless mesh network in some embodiments. Such an flexible electronic display device (or set of flexible electronic display devices) may receive, from the source device, the BLE characteristic message and/or BLE characteristic value declaration message that includes the message to be displayed and/or the light pattern to be displayed. The flexible electronic display device(s) may then translate the BLE characteristic declaration message and/or BLE characteristic value declaration message into a BLE advertising message. The flexible electronic display device(s) may then forward the BLE advertising message containing the message to display and/or light pattern to display to other nearby flexible electronic display devices (and/or other electronic display devices). Flexible electronic display devices that receive the BLE advertising message that includes the control message (e.g., that includes a command to display a message and/or to output a particular light pattern) may modify the received BLE advertising message and then re-broadcast or echo the modified version of the BLE advertising message.

Latency and distance are two important requirements which affect the firmware design of the flexible electronic display devices. The flexible electronic display devices are configured to implement the bi-directional wireless mesh network in a manner that minimizes latency over a very large area in embodiments. The low latency is important to achieve to enable the flexible electronic display devices to maintain synchronization across even large areas in embodiments. The wireless mesh network achieves at most a 0.5 second latency over a distance of approximately 400 meters in embodiments. In contrast, existing Bluetooth mesh network implementations are not able to achieve such low latency values, and thus cannot maintain synchronization between multiple members of the wireless mesh network at large distances. Existing Bluetooth Mesh network implementations therefore do not work, for example, for applications such as coordinated light displays and/or message displays at concerts. For example, the Bluetooth mesh specification requires a minimum 100 Ms between retransmissions of an advertisement protocol data unit (PDU). Accordingly, the low latency requirements of some applications such as light shows at concert venues cannot be met using traditional Bluetooth mesh.

In embodiments, the message structure for the bi-directional wireless mesh network includes three distinct layers. These three layers include a mesh layer, a message layer (also referred to as a command layer) and a security layer (also referred to as an encryption layer). The mesh layer deals with making sure that transmitted control messages are distributed quickly and efficiently throughout the bi-directional wireless mesh network. The message layer manages the actual commands sent over the wireless mesh network to be processed by the individual flexible electronic display devices. The security layer authenticates the messages (makes sure they were created by an authorized source device) and makes it difficult for third parties to create their own messages.

All of the control messages (referred to as protocol data units (PDUs)) sent may be composed of non-connectable undirected advertising messages in embodiments. The length of the PDU is variable according to the specific control message. The PDUs are structured to maximize the number of available bytes in the PDU. The PDU may have a maximum length of 27 Bytes if device discovery is enabled. Traditionally BLE uses three bytes for device discovery in packets. In one embodiment, the size of the PDUs may be increased by three additional bytes by using a non-discoverable mode and omitting the flags and their triplet associated with device discovery. This frees up the three bytes that are generally used for device discovery. Accordingly, when all of the available bytes are used for a control message, the control message may have a length of 30 bytes in some embodiments. An example advertising PDU is set forth below.

| 1 B | 1 B | 2 B | up to 27 B |
|---|---|---|---|
| Length | Type | Company | Mesh + Msg + Security |
| 3 + Max 27 | 0xFF | 0x000D | 2 B . . . 2 B? |

As shown, the first Byte in the advertising PDU may indicate a length of the PDU. In one embodiment, the 1B length of the length field is not included in the advertising PDU, freeing up an additional Byte for a remainder of the advertising PDU. As shown, the second Byte of the PDU identifies a device type, which may be manufacturer specific data. The third and fourth Bytes of the advertising PDU may identify a company identifier or code. The remaining Bytes of the advertising PDU include the body of the control message, which includes data for the mesh layer, data for the message layer, and data for the security layer.

The mesh layer is part of every advertising PDU sent on the network and by the source device. The mesh layer may include two Bytes of data in embodiments. An Example of the mesh layer is provided below.

| | |
|---|---|
| 1^{st} Byte | 2nd Byte |

| Bits | Bits | Bit | Bits | Bits |
|---|---|---|---|---|
| 0 . . . 3 | 4 . . . 5 | 6 | 7 | 8 . . . 15 |
| TTL | Type | TBD | Special | Message counter |

The first four bits of the mesh layer may include a time-to-live (TTL) value. The TTL value indicates the time to live for the advertising PDU, and helps trace the max number of hops for which the control message will exist. The source device may set this value according to the maximum range (e.g., maximum TTL (MaxTTL)) and this value is reduced with every long range repetition of the message. Accordingly, each flexible electronic display device that receives an advertising PDU may reduce the TTL value by 1, and then re-broadcast the advertising PDU with the reduced TTL value. If the TTL value is reduced to 0, then the control message is no longer re-broadcast.

The second two bits of the mesh layer may indicate a type, which may identify a type of broadcast and/or a type of broadcaster. The numbering in the below table indicates which transmission event a control message was advertised in (not counting transmissions on different channels) in accordance with one embodiment.

| Type | |
|---|---|
| value | Meaning |
| 0x0 | 1st transmission of message sent by source device/echoer |
| 0x1 | 2nd (or middle most) transmissions of messages sent by source |
| | device/echoer |
| 0x2 | Last transmission of message sent by source device/echoer |
| 0x3 | Currently not defined. |

The term echoer may refer to an flexible electronic display device that rebroadcasts or echoes a control message (e.g., an advertising PDU containing a control message).

In one embodiment, the seventh bit of the mesh layer is a “special” bit. The special bit may indicate that the mesh layer needs to consider more bytes from the rest of the message. This may be used for synchronizing the timing of the display of messages and/or light displays by flexible electronic display devices. If the “special” bit is set, then the mesh layer will add a time offset for when the message and/or light pattern is to be displayed by an flexible electronic display device. The amount of time offset may be based on the TTL value in an embodiment. For example, if the TTL value is 5, then the flexible electronic display device receiving the advertising PDU containing the control message may wait the amount of time that it takes for 5 rebroadcasts of the advertising PDU before displaying a message and/or light pattern included in the control message of the advertising PDU. The advertising PDU would have a TTL value of 4, and would wait the amount of time that it takes for 4 rebroadcasts of the advertising PDU before displaying the message and/or light pattern, and so on. Each flexible electronic display device which receives the advertising PDU may add a time offset for each echoing or between new advertising events. This offset may be added to a known position in the message which will not be encrypted. Accordingly, all flexible electronic display devices may display the message and/or light pattern in a synchronized manner.

The second Byte of the mesh layer may include a message counter. The message counter value may increment for each new message sent by the source device. The counter will overflow and restart after 256 messages in some embodiments, but the messages should be distant enough for the counter to be used to distinguish messages already encountered by the source device and/or flexible electronic display devices.

The mesh layer distributes the messages between the flexible electronic display devices within the required latency. Some of the flexible electronic display devices (nodes of the mesh network) will “echo” messages if the flexible electronic display device is at the edge of the broadcast range and the message is the first transmission event and first time the flexible electronic display device has received this message. Echoing such a message means starting a new hop (decrementing TTL) and re-broadcasting the message. This should happen statistically (random according to the number of nodes per hop) only on part of the nodes that meet this condition. After a first message is echoed by a source device or flexible electronic display device, a second message may be received from the source device. Second messages may or may not be echoed. If a second message is to be echoed, a timer will wait up to 100 Msec for a last message if it didn't arrive and the message was not received it may also be echoed. A last event will be echoed if this message was not yet received.

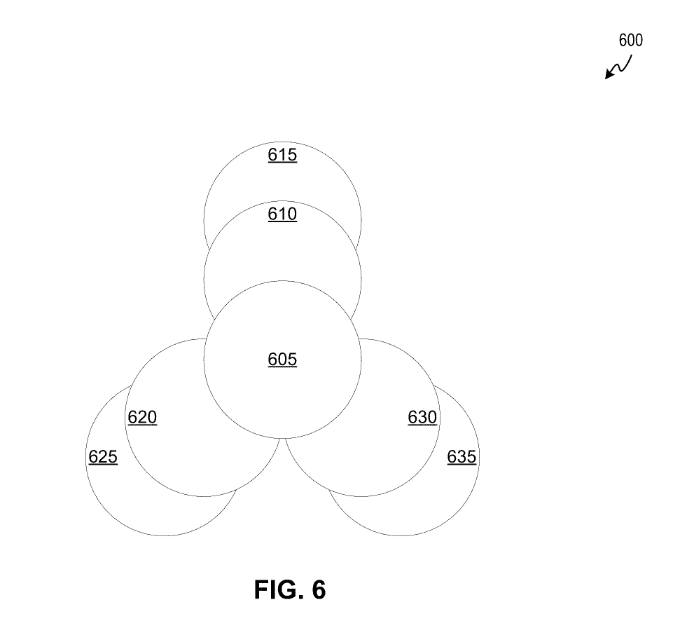

FIG. 6 illustrates multiple different areas of a mesh network and the distribution of a control message between the areas. As shown, three hops are performed of the control message. Each of the different hops may include more than one flexible electronic display device that are designed as echoers in order for the control message to reach all of the areas. The center area 605 represents the distribution of the message sent by the source device. Areas 610, 620 and 630 represent a first hop from the center area 605. Areas 615, 625 and 635 represent a second hop. Area 615 is a second hop from area 610, area 625 is a second hop from area 620, and area 635 is a second hop from area 630. If an flexible electronic display device (e.g., an echoer) receives a copy of a control message it already broadcast (echoed) with a higher TTL value, it will stop broadcasting this control message.

It can be useful for the source device to be located within range of at least a few dozen electronic display devices in some instances. In one embodiment, the source device will send out two different messages separated by a second or less. The source device should have a total of three advertising events for each message in an embodiment. Each event includes changing the type bits accordingly.

During an initialization phase, initial messages are sent by a source device to selected nodes (turning only these on and placing them close to the source device). The source device will set the TTL for the initial messages to 0 and during this phase will repeat at least 10 advertising events for each message sent. The source device should also set the transmit power level to minimum in some embodiments. The initialization messages may include the cryptographic keys, different parameters like MaxTTL, number of nodes, max distance, identifier (ID), etc.

As discussed above, the mesh network includes a message layer. Actual commands and their parameters are processed in the message layer. The general structure of a message in the message layer structure is set forth below.

| | | | | |
|---|---|---|---|---|
| 1 B | 0 . . . X B | 0 . . . Y B | . . . | . . . |
| OP code | [Parameter] | [Parameter] | [Parameter] | . . . |

Each Op code/cmd determines the form and the number and length of parameters.

Initialization messages for the message layer should be sent once at initialization phase. There may be multiple advertising events for the initialization messages. Other messages may also be sent at this phase.

| Op | | | Bytes per | |
|---|---|---|---|---|
| code | Cmd name | Parameters | parm | Total bytes |
| 0x00 | Not used. | non | 0 | 1 |
| 0x01 | Assign ID | ID | 4 | 5 |
| 0x02 | Sync time | mSecTime | 4 | 5 |
| 0x03 | Init Params | MaxTTL, | 1, | 6 . . . |
| | | #Nodes, | 4 | |
| | | . . . TBD | | |
| 0x04 | SetCryptoKey | keyType, | 1, | 18 |
| | | Key | 16 | |
| 0x05 | TBD | | | |
| 0x06 | TBD | | | |

The same ID may be assigned to multiple nodes. ID may also be assigned (e.g., sequentially assigned) at production phase or later. If the ID for a flexible electronic display device is changed, selector messages may be resent.

Various types of messages that may be included in the message layer for a control message (e.g., advertising PDU) are set forth below.

| Messages may also | | | | |
|---|---|---|---|---|
| be sent during | | | | |
| initialization phase. | | | Bytes per | Total |
| Op code | Cmd name | Parameters | parm | bytes |
| 0x07 | Set Selector | Selector, | 1, | 10 |
| | | Starting ID, | 4, | |
| | | Ending ID | 4 | |
| 0x08 | UnSet Selector | Selector, | 1, | 10 |
| | | Starting ID, | 4, | |
| | | Ending ID | 4 | |
| 0x09 | RGB start | Selector, | 1, | 5 |
| | TBD | R | 1, | |
| | | G | 1, | |
| | | B | 1 | |
| 0x0A | RGBPattern | Selector, | 1, | . . . |
| | | TBD | . . . | |
| 0x0B | StopRGB | Selector | 1 | 2 |
| 0x0C | ReSync | RelativeTime, | | |
| | TBD | TBD | | |
| 0x0C | DisplayText | Selector, | 1, | 3 |
| | | TextNum | 1 | |
| 0x0D | StopText | Selector | 1 | 2 |
| 0x0F | SetTextFull | Selector, | 1, | 22 |
| | | Pos, | 1, | |
| | | TextPointer, | 1, | |
| | | Text | 18 | |
| 0x10 | SetText00 | Selector, | 1, | 23? |
| | | Compressed | 21? | |
| | | text | | |
| 0x11 | SetText01 | Selector, | 1, | 23? |
| | | Compressed | 21? | |
| | | text | | |
| . . . | . . . | Selector, | 1, | 23? |
| | | Compressed | 21? | |
| | | text | | |
| 0x1A | SetText10 | Selector, | 1, | 23? |
| | | Compressed | 21? | |
| | | text | | |
| 0x1B | SetDispText | Selector, | 1, | 23? |
| | UnSaved | Compressed | 21? | |
| | | text | | |

The selector property represents a group of ID's. Multiple ID's may be defined for each selector. Multiple selectors may contain similar ID's. The set selector message may contain an ID range. If the starting ID is equal to the ending ID, it means a single ID is used. Selector messages may be sent at all times. For example, if a lottery wants to pick just one ID at random and send it a message, it may simply add a set selector to its ID before sending the message.

Text may be compressed. Compressed text may be packed as 3 chars into one byte by squeezing only the printable characters. But since this is the longest message it will be affected by the security layer final decision. Using this message enables a single message to be used for displaying text, but that single message will have fewer possible characters (e.g., about 63 characters).

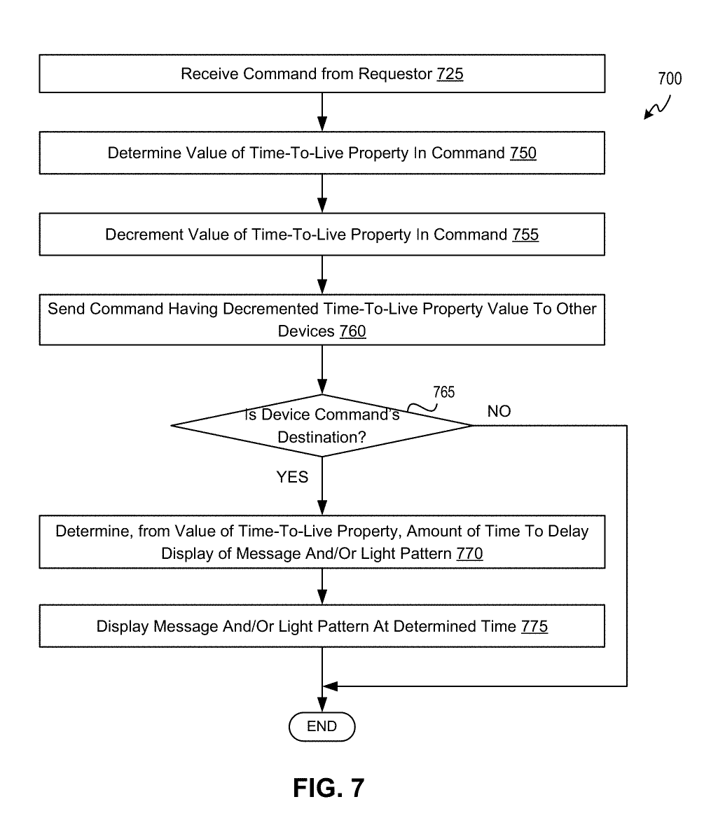

FIG. 7 is a flow chart of an embodiment of a method 700 for synchronizing display of messages between multiple devices in a mesh network. Method 700 and each of its individual functions, routines, subroutines, or operations may be performed by processing logic of a flexible electric display device, mobile computing device, or server computing device executing the method. The processing logic may include hardware, software, firmware, or a combination thereof. For example, processing logic may include a general purpose and/or special purpose processor that executes instructions for performing the method.

At block 725 of method 700, a flexible electronic display device receives a command from a requestor. The command may be a control message that may include a message to display (e.g., a text message) and/or a command to display a message already stored in a memory of the flexible electronic display device. At block 750, the flexible electronic display device determines a value of a time-to-live property in the received command. The value of the time-to-live property may indicate a number or retransmissions of the command that are to be sent. At block 755, the flexible electronic display device decrements the value of the time-to-live property in the command. At block 760, processing logic sends the command having the decremented time-to-live property value to one or more other electronic display devices.

At block 765, the flexible electronic display device determines if it was a destination for the command (e.g., if the command was addressed to a group that includes the flexible electronic display device). If the flexible electronic display device was not a destination for the command, the method ends. If the flexible electronic display device was a destination for the command, the method continues to block 770.

At block 770, the flexible electronic display device determines, from the value of the time-to-live property, an amount of time to delay a display of the message and/or light pattern. The delay may be determined from the original value of the time-to-live property that the command had on receipt by the flexible electronic display device or from the decremented value of the time-to-live property. At block 775, the flexible electronic display device then displays the message at the determined time.

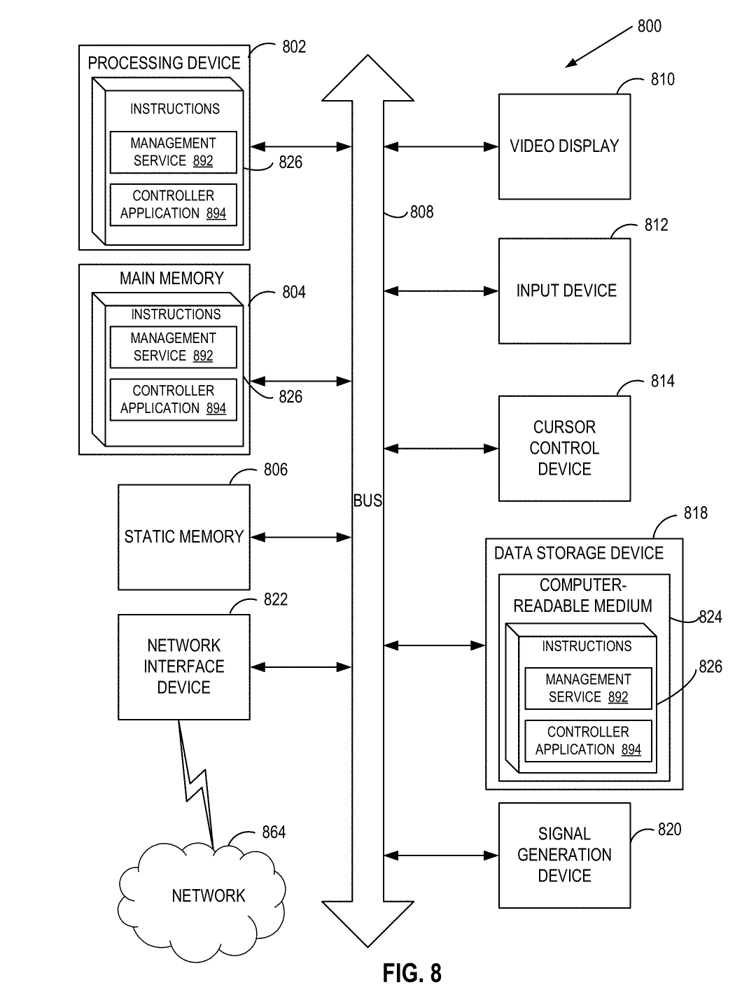

FIG. 8 depicts a block diagram of a computer system operating in accordance with one or more aspects of the present disclosure. In various illustrative examples, computer system 800 may correspond to flexible electronic display devices 310A-C, mobile computing device 326, server computing device 350 and/or computing device 340 of FIG. 3.

In certain implementations, computer system 800 may be connected (e.g., via a network, such as a Local Area Network (LAN), an intranet, an extranet, or the Internet) to other computer systems. Computer system 800 may operate in the capacity of a server or a client computer in a client-server environment, or as a peer computer in a peer-to-peer or distributed network environment. Computer system 800 may be provided by a personal computer (PC), a tablet PC, a set-top box (STB), a Personal Digital Assistant (PDA), a cellular telephone, a web appliance, a laptop computer, a tablet computer, a server computing device, a network router, switch or bridge, an electronic display device, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 800 may include a processing device 802, a main (volatile) memory 804 (e.g., random access memory (RAM)), a static (non-volatile) memory 806 (e.g., read-only memory (ROM) or electrically-erasable programmable ROM (EEPROM)), and/or a data storage device 818, which may communicate with each other via a bus 808.

Processing device 802 may be provided by one or more processing devices such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 800 may further include a network interface device 822 (e.g., a wireless communication module, wireless modem, etc.). Computer system 800 also may include a video display unit 810 (e.g., an LCD), an input device 812 (e.g., a keyboard, touch screen, touchpad, etc.), and a cursor control device 814 (e.g., a mouse).

Data storage device 818 may include a non-transitory computer-readable storage medium 824 on which it may store instructions 826 encoding any one or more of the methods or functions described herein, including instructions encoding methods 400, 500 and/or 700 for controlling flexible electronic display devices. For example, data storage device 818 may include instructions 826 for an electronic device management service 892 and/or an electronic device controller application 894, which may correspond to similarly named components described earlier herein.

Instructions 826 may also reside, completely or partially, within main memory 804 and/or within processing device 802 during execution thereof by computer system 800, hence, main memory 804 and processing device 802 may also constitute machine-readable storage media.

While computer-readable storage medium 824 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any non-transitory tangible medium that is capable of storing or encoding a set of instructions for execution by a computer or device that cause the computer or device to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

Unless specifically stated otherwise, terms such as “receiving”, “identifying”, “determining”, “transmitting”, “displaying”, or the like, refer to actions and processes performed or implemented by a computer system that manipulates and transforms data represented as physical (electronic) quantities within the computer system registers and memories into other data similarly represented as physical quantities within the computer system memories or registers or other such information storage or display devices. Also, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A flexible electronic display device, comprising:
a flexible circuit board;
a plurality of components mounted to the flexible circuit board, the plurality of components comprising:
one or more battery;
one or more integrated circuits; and
a plurality of light emitting elements; and
an adhesive on a backside of the flexible circuit board.

2. The flexible electronic display device of claim 1, wherein the flexible electronic display device is configured to assume a plurality of different shapes and to conform to a shape of a surface onto which the flexible display device is attached.

3. The flexible electronic display device of claim 1, wherein the one or more integrated circuits comprise a Bluetooth module and the plurality of light emitting elements comprise a plurality of light emitting diodes (LEDs).

4. The flexible electronic display device of claim 1, further comprising:
a container having a cylindrical shape, wherein the adhesive couples the flexible electronic display device to a surface of the container, and wherein the flexible electronic display device has the cylindrical shape.

5. The flexible electronic display device of claim 4, wherein the container is a bottle.

6. The flexible electronic display device of claim 1, the plurality of components further comprising:
a first wireless module comprising a radio, wherein the first wireless module is configured to implement a bi-directional wireless mesh network using the radio.

7. The flexible electronic display device of claim 6, wherein the first wireless module comprises a Bluetooth adapter and the bi-directional wireless mesh network comprises a Bluetooth mesh network.

8. The flexible electronic display device of claim 6, wherein the radio is an only radio of the first wireless module, and wherein the first wireless module is configured to concurrently receive data at a first frequency range using the radio and to second at least one of the data or additional data at a second frequency range using the radio.

9. The flexible electronic display device of claim 6, wherein the one or more integrated circuits are further to:
receive a command to display a message via the first wireless module, wherein the command is addressed to one or more groups in a group hierarchy;
determine whether the flexible electronic display device is a member of the one or more groups;
display the message responsive to determining that the flexible electronic display device is a member of the one or more groups; and
send the command to one or more additional flexible electronic display devices that are connected to the flexible electronic display device via a mesh network.

10. The flexible electronic display device of claim 9, wherein the one or more integrated circuits are further to:
determine a value of a time-to-live property in the command, wherein the time-to-live property represents a number of rebroadcasts of the command to be made;
determine, from the value of the time-to-live property, an amount of time to delay the display of the message, wherein the message is displayed after the amount of time; and
decrement the value of the time-to-live property before sending the command to the one or more additional flexible electronic display devices.

11. The flexible electronic display device of claim 9, wherein the command is received as an advertising message and is received over an advertising channel of a wireless protocol implemented by the radio.

12. The flexible electronic display device of claim 9, wherein the command is received as a characteristic declaration message, wherein the one or more integrated circuits are to translate the characteristic declaration message comprising the command into an advertising message comprising the command, and wherein the command sent to the one or more additional flexible electronic display devices is sent as the advertising message.

13. The flexible electronic display device of claim 9, wherein the display of the message by the one or more integrated circuits is synchronized with display of the message by the one or more additional flexible electronic display devices.

14. The flexible electronic display device of claim 6, wherein the bi-directional wireless mesh network comprises a latency of less than 0.5 seconds for a distance of approximately 400 meters.

15. The flexible electronic display device of claim 6, wherein the bi-directional wireless mesh network comprises a mesh layer, a message layer and a security layer, wherein the mesh layer distributes commands between nodes of the bi-directional wireless mesh network within a required latency, wherein the message layer processes the commands, and wherein the security layer authenticates the commands.

16. A method comprising:
receiving, by a flexible electronic display device, a command to display a message, wherein the command is addressed to one or more groups in a group hierarchy;
determining, by the flexible electronic display device, whether the flexible electronic display device is a member of the one or more groups;
displaying, by the flexible electronic display device, the message responsive to determining that the flexible electronic display device is a member of the one or more groups; and
sending, by the flexible electronic display device, the command to one or more additional electronic display devices that are connected to the flexible electronic display device via a mesh network.

17. The method of claim 16, further comprising:
determining a value of a time-to-live property in the command, wherein the time-to-live property represents a number of rebroadcasts of the command to be made; and
determining, from the value of the time-to-live property, an amount of time to delay the display of the message, wherein the message is displayed after the amount of time.

18. The method of claim 17, further comprising:
decrementing the value of the time-to-live property before sending the command to the one or more additional electronic display devices.

19. The method of claim 16, wherein the mesh network comprises a mesh layer, a message layer and a security layer, wherein the mesh layer distributes commands between nodes of the mesh network within a required latency, wherein the message layer processes the commands, and wherein the security layer authenticates the commands.

20. The method of claim 16, wherein the mesh network comprises a latency of less than 0.5 seconds for a distance of approximately 400 meters.
